(19) United States
(12) Patent Application Publication
(10) Pub. No.: US 2026/0026558 A1
(43) Pub. Date: Jan. 29, 2026

(54) CONSUMABLE ASSEMBLY FOR AN AEROSOL-GENERATING SYSTEM

(71) Applicant: Philip Morris Products S.A., Neuchatel (CH)

(72) Inventor: Onur DAYIOGLU, Neuchâtel (CH)

(73) Assignee: Philip Morris Products S.A., Neuchatel (CH)

(21) Appl. No.: 18/997,671

(22) PCT Filed: Aug. 10, 2023
(86) PCT No.: PCT/EP2023/072231

§ 371 Date: Jan. 22, 2025

(30) Foreign Application Priority Data
Aug. 11, 2022 (EP) 22189978.4

(51) Int. Cl. A24F 40/70; A24F 40/10; A24F 40/42; A24F 40/44; A24F 40/465; H05B 6/10

(52) U.S. Cl. CPC A24F 40/70; A24F 40/10; A24F 40/42; A24F 40/44; A24F 40/465; H05B 6/108

(57) ABSTRACT

A method for manufacturing one or more consumable assemblies for an aerosol-generating device, including: providing susceptors across a width of a strip of wicking material to form respective susceptor assemblies; folding the strip widthways such that the susceptors are provided on an outer surface of each side of the folded strip; sliding first susceptor holder portions onto the strip to engage the susceptor assemblies, the first portions each including a hollow elongate portion having an opening at a connection end and two opposing slots extending from the opening at the connection end, the slots being configured to receive and engage the strip on either side of the susceptor assembly as it is received within the hollow portion; and attaching a second susceptor holder portion to the connection end of each of the first portions to retain the strip including the susceptor assemblies within the first portions.

The present disclosure relates to a consumable assembly for an aerosol-generating system; and methods for manufacturing a consumable assembly for an aerosol-generating system.

Aerosol-generating systems that employ inductive heating to heat an aerosol-forming substrate in order to generate an aerosol for user inhalation are generally known in the art. An aerosol-forming substrate is heated and vaporised to form a vapour. The vapour cools and condenses to form an aerosol, this aerosol is then inhaled by a user. Such electrically heated smoking systems are typically handheld and comprise a power supply, a reservoir for holding a supply of the aerosol-forming substrate and an inductive heating system.

Inductive heating systems typically comprise at least one inductor coil connected to the power supply. The inductive heating systems comprise a susceptor assembly comprising a susceptor arranged in close proximity to the aerosol-forming substrate and within the alternating magnetic field. Some aerosol-generating systems comprise an aerosol-generating device and a cartridge that is configured to be used with the device. When the aerosol generating system comprises an aerosol-generating device and a cartridge, the susceptor assembly may form part of the cartridge.

The aerosol-forming substrate may be a liquid. In such cases, the susceptor assembly may further comprise a wicking material configured to draw liquid aerosol-forming substrate from a reservoir in a cartridge to the susceptor to be heated.

Typically, a cartridge comprising a susceptor assembly and a liquid aerosol-forming substrate reservoir is formed by inserting the susceptor assembly through a slot in the walls of a hollow elongate susceptor holder. The susceptor assembly must be secured within the susceptor holder such that the wicking material of the susceptor assembly protrudes through the slot in the susceptor holder to maintain fluid communication with a liquid aerosol-forming substrate reservoir surrounding the susceptor holder. Manufacturing an aerosol-generating cartridge in this manner can be a cumbersome process, unsuitable for large scale production.

It would be desirable to provide a manufacturing process for efficiently forming consumable assemblies comprising a susceptor assembly within a susceptor holder for inductive aerosol-generating device cartridges. It would also be desirable to provide a consumable assembly for inductive aerosol-generating device cartridges which is easier to manufacture.

In accordance with a first aspect of the present disclosure, there is provided a consumable assembly for use in an aerosol-generating device. The consumable assembly may comprise a susceptor holder housing a susceptor assembly comprising a susceptor on a strip of wicking material. The susceptor holder may comprise a first portion comprising a hollow elongate portion housing the susceptor assembly. The hollow elongate portion may have an opening at a connection end. The hollow elongate portion may comprise two opposing slots extending from the opening at the connection end along the elongate portion. Wicking material either side of the susceptor of the susceptor assembly may protrude through the slots in the first portion. A second portion may be attached to the connection end of the first portion to retain the susceptor assembly within the first portion.

Advantageously, assembling two portions of a susceptor holder around a strip of wicking material comprising a susceptor assembly facilitates the rapid construction of a consumable assembly. Specifically, rather than awkwardly feeding a susceptor assembly through a slot in a wall of a susceptor holder and securing the susceptor assembly in place within the susceptor holder while maintaining a portion of wicking material outside the susceptor holder, a susceptor assembly formed on a strip of wicking material may be fed into the hollow elongate portion of the first susceptor holder portion via the opening in the connection end while portions of the strip of wicking material are received within the slots in the first susceptor holder portion. The susceptor assembly may then be retained within the first susceptor holder portion by attaching a second susceptor holder portion to the connection end of the first susceptor holder portion. The proposed consumable assembly is therefore easier to manufacture since the need for precise positioning of a susceptor assembly through a slot in a susceptor holder is avoided. Instead, the proposed consumable assembly may be reliably and efficiently manufactured by assembling two portions of a susceptor holder around a susceptor assembly.

The wicking material may be configured to transport liquid aerosol-forming substrate to the susceptor. The susceptor may be configured to heat and vaporise the liquid aerosol-forming substrate.

The slots in the first susceptor holder portion may be sized to have a width greater than the wicking material, but smaller than that of the susceptor assembly. This advantageously prevents the susceptor assembly from sliding out of the first susceptor holder portion through the slots.

The slots in the first susceptor holder portion may have a length larger than the width of the strip of wicking material. Advantageously, this results in the strip of wicking material being fully housed within the slots.

The width of the slots in the first susceptor holder portion may increase at the connection end. This may facilitate easier insertion of the strip of wicking material into the slots.

The second susceptor holder portion may retain the susceptor assembly within the first susceptor holder portion via one or more different mechanisms. The connection between the first susceptor holder portion and the second susceptor holder portion may exert a biasing force against the wicking material or the susceptor assembly. In one example, when connected to the first susceptor holder portion, the second susceptor holder portion may block the wicking material from sliding out of the slots at the connection end of the first susceptor holder portion. In one example, when connected to the first susceptor holder portion, the second susceptor holder portion may block the susceptor assembly from sliding out of the first susceptor holder portion via the opening at the connection end. In one example, when connected to the first susceptor holder portion, the second susceptor holder portion may exert a biasing force onto the wicking material or susceptor assembly against the first susceptor holder portion, thereby, retaining the susceptor assembly in position. In another example, when connected to the first susceptor holder portion, the second susceptor holder portion may exert a biasing force on the first susceptor holder portion, causing part of the first susceptor holder portion to deform against the wicking material to hold the susceptor assembly in position. It will be appreciated that any known connection mechanism for providing the above-mentioned biasing force may be utilised.

The second susceptor holder portion may form a snap-fit connection with the first susceptor holder portion via the connection end. The snap-fit connection may be irreversible to indefinitely retain the susceptor assembly within the first susceptor holder portion following attachment of the second susceptor holder portion.

A surface of the first susceptor holder portion at the connection end may comprise a screw thread and the second susceptor holder portion may comprise a corresponding screw thread for forming a screw connection with the first susceptor holder portion. The thread on the first susceptor holder portion may be located on an outer surface of the first susceptor holder portion while the thread on the second susceptor holder portion may be located on an inner surface of the second susceptor holder portion. Alternatively, the thread on the first susceptor holder portion may be located on an inner surface of the first susceptor holder portion while the thread on the second susceptor holder portion may be located on an outer surface of the second susceptor holder portion.

The second susceptor holder portion may comprise a hollow portion and an opening at a connection end for connection with the connection end of the first susceptor holder portion. The connection end of the second susceptor holder portion may comprises two opposing slots extending from the opening. The slots in the second susceptor holder portion may be configured to receive at least a portion of the strip of wicking material when the second susceptor holder portion is attached to the first susceptor holder portion. Advantageously, when the second susceptor holder portion is attached to the first susceptor holder portion, the slots in the second susceptor holder portion may engage and receive a part of the strip of wicking material. This may improve retention of the susceptor assembly within the first susceptor holder portion and restrict rotation of the second susceptor holder portion while attached to the first susceptor holder portion.

The susceptor may comprises a first susceptor layer and a second susceptor layer. Accordingly, the strip of wicking material may comprise a first wicking layer and a second wicking layer. The first susceptor layer may be in contact with at least a portion of the first wicking layer, and the second susceptor layer may be in contact with at least a portion of the second wicking layer. This may advantageously mean that, in operation, the wicking material is heated from two sides. This may increase the amount of aerosol-forming substrate that is vaporised in a given time compared to a susceptor assembly comprising only one susceptor layer.

The first susceptor layer and second susceptor layer may be planar. In this context a planar susceptor layer is a susceptor layer having a substantially greater length and width than thickness. The length and width directions are orthogonal to one another and define the first plane. A planar susceptor layer may have two opposing major surfaces extending in planes parallel to the first plane. One or both major surfaces is advantageously flat. During use of the first susceptor layer and second susceptor layer in an aerosol-generating system, this may allow air to flow across a surface of both the first susceptor layer and second susceptor layer, enhancing the entrainment of vapourised aerosol-forming substrate. The first susceptor layer and second susceptor layer may be substantially parallel to one another. The first susceptor layer and the second susceptor layer may have a rectangular cross-section taken across the first plane.

The first susceptor layer and second susceptor layer may be separate components.

The first susceptor layer and the second susceptor layer may be integral with each other.

Advantageously, this may simplify manufacturing of the susceptor assembly.

The susceptor may comprise a connection section that connects the first susceptor layer to the second susceptor layer. The susceptor may comprise three sections. The first section of the susceptor may comprise the first susceptor layer. The second section of the susceptor may comprise the second susceptor layer. The third section of the susceptor may be the connection section joining the first susceptor layer to the second susceptor layer.

The connection section may be U-shaped or V-shaped. Advantageously, a susceptor with a U-shaped or V-shaped connection section may hold the first and second wicking layers in contact with the first and second susceptor layers.

The susceptor may be formed by bending or folding a single piece of susceptor material to form the first susceptor layer, the second susceptor layer and the connection section of the susceptor. Advantageously, a susceptor formed in this way may be relatively simple to manufacture.

The first wicking layer and second wicking layer may be substantially planar. The first wicking layer and the second wicking layer of the susceptor assembly may be substantially parallel.

The first wicking layer and the second wicking layer may be integral with each other. The first wicking layer and the second wicking layer may be formed from a single piece of wicking material.

The first wicking layer and the second wicking layer may be separate components. Advantageously, the first wicking layer and the second wicking layer being separate components may prevent any bends or folds in the wicking layers that could compress the wicking layer and lead to suboptimal liquid transport.

The susceptor assembly may be substantially planar. The susceptor assembly may have a rectangular cross-section taken across the first plane.

The susceptor assembly may comprise a heating region and at least one mounting region. The heating region is a region of the susceptor assembly that is configured to be heated to a temperature required to vaporise the aerosol-forming substrate upon penetration by a suitable alternating magnetic field. The heating region of the susceptor assembly may comprise at least a portion of the first susceptor layer. The heating region of the susceptor assembly may comprise at least a portion of the second susceptor layer. Each of the first susceptor layer, second susceptor layer, first wicking layer, and second wicking layer may comprise a heating region.

Each of the first wicking layer, and second wicking layer may comprise a mounting region. The at least one mounting region may be in contact with a susceptor holder. Preferably, when the susceptor assembly is inserted within a cartridge, a portion of the at least one mounting region may extend into a liquid reservoir. In preferred embodiments, the heating region may be arranged outside of the liquid reservoir. Advantageously, arranging the susceptor substantially outside of the liquid reservoir, and particularly arranging the heating region of the first susceptor layer and the second susceptor layer outside of the liquid reservoir, may ensure that the aerosol-forming substrate is heated sufficiently to release the volatile compounds only after the aerosol-forming substrate has been transported outside of the liquid reservoir. This may facilitate release of the volatile compounds from the aerosol-generating system.

In preferred embodiments, the cross-sectional area of the wicking material taken across the first plane is greater than the cross sectional area of the susceptor taken across the first plane. The length of the first susceptor layer and the length of the second susceptor layer may be about equal to the length of the first wicking layer and the second wicking layer.

The width of the first susceptor layer and the second susceptor layer may be smaller than the width of the of the first wicking layer, and the second wicking layer. The width of the first susceptor layer and the second susceptor layer may be about 20 percent smaller than the width of the of the first wicking layer and the second wicking layer. The width of the first susceptor layer and second susceptor layer may be about equal to the width of the heating region of the first wicking layer and the second wicking layer. The first susceptor layer and the second susceptor layer may not comprise a mounting region.

The first susceptor layer and the second susceptor layer may comprise a mounting region.

The susceptor assembly may form a shape of a cross. The first susceptor layer, the second susceptor layer, the first wicking layer, and the second wicking layer may have a cross-shaped cross-section along the first plane. The susceptor assembly may comprise a pair of mounting regions and a heating region. The heating region may be substantially rectangular and located centrally on the susceptor assembly. The pair of mounting regions may be substantially rectangular regions located at the periphery of the heating region. The mounting regions may be located at opposite sides of the heating region. The mounting regions may be arranged at the same central position along the length of the heating region. Each of the pair of mounting regions may have a smaller surface area than the heating region.

The strip of wicking material may comprise a capillary material. The first wicking layer may comprise a capillary material. The second wicking layer may comprise a capillary material. A capillary material is a material that is capable of transport of liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. In some embodiments, the capillary material may comprise sponge-like or foam-like material. The structure of the capillary material may form a plurality of small bores or tubes, through which liquid aerosol-forming substrate can be transported by capillary action.

The wicking material may comprise or consist of an electrically insulating material. The wicking material may comprise a non-metallic material. The wicking material may comprise a hydrophilic material or an oleophilic material. This may advantageously encourage the transport of the aerosol-forming substrate through the wicking material. The wicking material may comprise or consist of a porous ceramic material.

The wicking material may comprise a non-metallic material. Examples of suitable materials for the wicking material are sponge or foam materials, ceramic- or graphite-based materials in the form of fibres or sintered powders, foamed metal or plastics materials, fibrous materials, for example made of spun or extruded fibres, such as glass fibre, cellulose acetate, polyester, or bonded polyolefin, polyethylene, terylene or polypropylene fibres, nylon fibres or ceramic. Suitable materials for the wicking material may comprise cellulosic materials, such as cotton or rayon.

The wicking material may preferably comprise cotton, rayon or glass fibre. The first wicking layer may preferably comprise of consist of cotton. The second wicking layer may preferably comprise or consist of cotton.

The first wicking layer may have a thickness of between 0.1 and 0.5 millimetres. Preferably, the first wicking layer may have a thickness between 0.2 millimetres. The second wicking layer may have a thickness of between 0.1 and 0.5 millimetres. Preferably, the second wicking layer may have a thickness between 0.2 millimetres.

A distance between the first wicking layer and the second wicking layer may be between 0.1 and 0.5 millimetres. Preferably, the distance between the first wicking layer and the second wicking layer may be between 0.2 and 0.4 millimetres.

The susceptor may be fluid permeable. The first susceptor layer may be fluid permeable. The second susceptor layer may be fluid permeable. A fluid permeable susceptor may advantageously allow vaporised aerosol-forming substrate to escape through the susceptor. Therefore, the aerosol-forming substrate vapour generated in a region of the wicking material immediately adjacent to the susceptor may escape through the susceptor without needing to pass through the wicking material.

As used herein, a “susceptor” means an element that is heatable by penetration with an alternating magnetic field. A susceptor is typically heatable by at least one of Joule heating through induction of eddy currents in the susceptor, and hysteresis losses. Possible materials for the susceptors include graphite, molybdenum, silicon carbide, stainless steels, niobium, aluminium and virtually any other conductive elements. Advantageously the first and second susceptors may be ferrite elements. The material and the geometry for the susceptors can be chosen to provide a desired electrical resistance and heat generation. Preferably, the first and second susceptor comprises AISI 430 stainless steel.

Advantageously, in an aerosol-generating system that uses inductive heating, no electrical contacts need be formed between the susceptor assembly and a power supply. This may eliminate the need for solder or other bonding elements. A cartridge incorporating a susceptor assembly which is configured to be inductively heated may allow production of a cartridge that is simple, inexpensive and robust.

The susceptor or susceptors may be printed or otherwise deposited on the strip of wicking material, as a film or plurality of tracks. The susceptor or susceptors may be secured to the wicking material by folding free edges of the susceptor or susceptors around the strip of wicking material. The free edges of the folded susceptor may be welded together to secured the susceptor around the strip of wicking material. Preferably, the susceptor or susceptors are provided across the width of the strip of wicking material. The susceptor may comprise or consist of an electrically conductive material deposited directly onto the wicking material. The electrically conductive material of the susceptor may be deposited on to the wicking material as a plurality of tracks. In operation, vaporised aerosol-forming substrate may advantageously escape from the wicking material through gaps or spaces between the tracks. The plurality of tracks of each of the susceptors may advantageously be distributed over a surface of the wicking material to provide substantially uniform heating across that surface. For example, the width of each of the tracks and the spacing between the tracks may be substantially the same for each of the plurality of tracks. The plurality of tracks of each of the susceptors may comprise a first set of tracks parallel to one another. The plurality of tracks may further comprise a second set of tracks perpendicular to the first set of tracks and overlapping the first set of tracks. The first and second sets of tracks may together form a mesh-like structure.

The susceptor may comprise or consist of a perforated foil. In operation, vaporised aerosol-forming substrate may advantageously escape from the wicking material through the perforations of the perforated foil. The perforations may be uniformly distributed across the susceptor. The susceptor may be perforated to allow for the egress of vapour from the susceptor assembly or to allow for the ingress of liquid aerosol-forming substrate.

The susceptor may comprise electrically conductive filaments. The susceptor may comprise or consist of electrically conductive filaments.

In preferred embodiment, the susceptor may comprise a mesh. As used herein the term “mesh” encompasses grids and arrays of filaments having spaces therebetween. The term mesh also includes woven and non-woven fabrics.

The filaments may define interstices between the filaments and the interstices may have a width of between 10 micrometres and 100 micrometres. Preferably the filaments give rise to capillary action in the interstices, so that in use, the liquid aerosol-forming substrate is drawn into the interstices, increasing the contact area between the susceptor and the liquid. In operation, vaporised aerosol-forming substrate may advantageously escape from the wicking material through interstices between the filaments of the susceptor.

Each susceptor may have a thickness of no more than two millimetres. Preferably, each susceptor may have a thickness of less than one millimetre. Particularly preferably the susceptor may have a thickness of between 0.1 and 0.2 millimetres. The thickness of each of the susceptor is advantageously of a similar order to the skin depth of the material of the susceptor at the frequency of operation of the system. Advantageously the susceptor assembly has a thickness of no greater than ten times the skin depth of the material of the susceptor at the frequency of operation. This may ensure that each of susceptors have a suitably low mass and so the time taken for the susceptor to reach a temperature suitable for volatizing the aerosol-forming substrate is low. When the susceptor is penetrated by alternating magnetic fields from opposing sides, the susceptor may advantageously have a thickness of at least twice the skin depth of the material of the susceptor at the frequency of operation. This may minimize the interaction of the skin effects on opposing sides of the susceptor.

Advantageously the susceptor assembly may be configured to hold only a small volume of liquid aerosol-forming substrate, sufficient for a single user puff. This is advantageous because it allows that small volume of liquid to be vaporised rapidly, with minimal heat loss. Advantageously, the susceptor assembly, or a heating region of the susceptor assembly may hold between 2 millilitres and 10 millilitres of liquid aerosol-forming substrate.

The thickness of the susceptor assembly may be no more than two millimetres. Preferably, the susceptor assembly has a thickness of between 0.8 millimetres and 1.2 millimetres.

The susceptor assembly may comprise a spacer layer between the first and second wicking layers. It has been found that two layers of wicking material in contact with each other may lead to condensation formation that becomes trapped between the two layers of wicking material. This may then cause a release of steam. The steam may cause deformation of the susceptor. Deformation of the susceptor may in turn lead to reduced contact between the susceptor and wicking material, leading to reduced or inefficient aerosolisation of the liquid aerosol-forming substrate. Advantageously, the spacer layer may improve liquid flow between the first wicking layer and the second wicking layer and therefore may prevent the build-up of condensation between the two layers.

A first side of the spacer layer may be in contact with a first side of the first wicking layer and the first susceptor layer may be in contact with a second side of the first wicking layer, wherein the first side of the first wicking layer opposes the second side of the first wicking layer. A second side of the spacer layer may be in contact with a first side of the second wicking layer and the second susceptor layer may be in contact with a second side of the second wicking layer, wherein the first side of the second wicking layer opposes the second side of the second wicking layer. The first side of the spacer layer may oppose the second side of the spacer layer. In this arrangement, the first susceptor layer and second susceptor layer may be sufficiently spaced from each other. The first wicking layer may be configured to transport liquid aerosol-forming substrate to the first susceptor layer. The second wicking layer may be configured to transport liquid aerosol-forming substrate to the second susceptor layer. This may allow delivery of liquid aerosol-forming to be balanced between the first susceptor layer and the second susceptor layer.

The spacer layer may be fluid permeable. As used herein, a “fluid permeable” element means an element that allows liquid or gas to permeate through it.

The spacer layer may be substantially planar, having a substantially greater length and width than thickness. The length and width directions are orthogonal to one another and define the first plane of the spacer layer. The first side of the spacer layer and the second side of the spacer layer may oppose each other and extend in planes parallel to the first plane of the susceptor. The spacer layer may be configured to transport liquid aerosol-forming substrate between the first side of the spacer layer and the second side of the spacer layer.

The spacer layer may be configured to transport the liquid aerosol-forming substrate between the first wicking layer and the second wicking layer. In particular, when the first wicking layer is in contact with the first side of the spacer layer and the second wicking layer is in contact with the second side of the spacer layer.

The first wicking layer may be in contact with a first side of the spacer layer and the second wicking layer is in contact with a second side of the spacer layer. The spacer layer may separate the first wicking layer from the second wicking layer. Advantageously, the spacer layer may prevent the first wicking layer from being in contact with the second wicking layer, and therefore reduce the build-up of undesirable condensation between the first wicking layer and the second wicking layer.

The spacer layer may comprise a porous material. The spacer layer may comprise more pores than the wicking material. The spacer layer may comprise larger pores than the wicking material. The spacer layer may be more porous that the wicking material.

The spacer layer may comprise a capillary material. The spacer layer may comprise more small bores or tubes, through which liquid aerosol-forming substrate can be transported by capillary action, than the wicking material. The spacer layer may comprise larger bores or tubes, through which liquid aerosol-forming substrate can be transported by capillary action, than the wicking material. In this way the liquid aerosol-forming substrate may be transported more rapidly through the spacer layer compared to the wicking material.

The spacer layer may comprise a mesh. As used herein the term “mesh” encompasses grids and arrays of filaments having spaces therebetween. The term mesh also includes woven and non-woven fabrics.

The spacer layer may preferably comprise or consist of cotton. The spacer layer may comprise a plastics material. The spacer layer may comprise a polyetheretherketone (PEEK) film. The spacer layer may comprise a fibre sheet.

The spacer layer may comprise an aperture configured to transport of liquid aerosol-forming substrate between the first wicking layer and the second wicking layer. The spacer layer may comprise a plurality of apertures configured to transport of liquid aerosol-forming substrate between the first wicking layer and the second wicking layer.

The aperture or apertures may be defined through the spacer layer, between the first side of the spacer layer and the second side of the spacer layer. In this way liquid aerosol-forming substrate may be transported through aperture or apertures between the first side of the spacer layer and the second side of the spacer layer.

The aperture or apertures may have a circular cross-section. The aperture or apertures may have a diameter of at least 0.1 millimetres.

The aperture or apertures may have rectangular cross-section. The aperture or apertures may be defined at an end of the spacer layer. The aperture or apertures may be configured to enhance transport of the liquid aerosol-forming substrate from the liquid reservoir to a centre of the spacer layer.

The spacer layer may comprise one or more of curves, undulations, folds, and corrugations. The spacer layer may have a first end and a second end. A width of the spacer layer may extend from the first end to the second end. Where the spacer layer does not extend directly from the first end to the second, i.e. in a straight line, the spacer layer may be considered to comprise one or more of curves, undulations, folds, and corrugations.

A curve may refer to a gradual change in direction of the spacer layer, for example a gradual change in direction of the spacer layer between the first end and the second end. Thus, a curve may form an arc, or a “C” shape. A curve in the spacer layer may enhance transport of liquid aerosol-forming substrate between the first wicking layer and the second wicking layer.

A spacer layer may comprise a curve configured to act as a spring element between the first and second wicking layers. The spring may be resiliently biased to hold the first wicking layer and second wicking layer at a predetermined distance apart. The distance apart may pre-set by the adjusting the radius of the curve. Advantageously, a spacer layer comprising a curve configured to act as a spring element may press against the first and second wicking layers, ensuring good contact between the spacer layer and wicking material.

A fold may refer to a change in direction of the spacer layer, for example a step change in direction of the spacer layer between the first end and the second end. Thus, a fold may form two sides of a polygon, or a “V” shape.

An undulation may comprise multiple curves. For example, an undulation may refer to a gradual change in direction of the spacer layer in a first direction, followed by a gradual change in direction of the spacer layer in another, for example opposite, direction. Thus, an undulation may form a sinusoidal wave, or an “S” shape. Multiple undulations may be known as wave corrugations. The spacer layer may comprise wave corrugations.

A corrugation may comprise multiple folds. For example, a corrugation may refer to a step change in direction of the spacer layer, followed by another step change in direction of the spacer layer. Thus, a corrugation may form three sides of a rectangle, or an “M” shape, or an “N” shape. Multiple corrugations comprising “V” shaped folds may be known as triangular corrugations. The spacer layer may comprise triangular corrugations.

The corrugations may be formed by bending or folding a spacer material to form the spacer layer. The corrugations may be formed by moulding a spacer material to form the spacer layer.

The undulations, or corrugations of the spacer layer may enhance the flow of liquid aerosol-forming substrate between the first layer of the wicking material and the second layer of the wicking material.

A thickness of the spacer layer may be between 0.1 and 0.5 millimetres. As used herein the thickness of the spacer layer is defined as the distance between the first side of the spacer layer and the second side of the spacer layer. Preferably, the thickness of the spacer layer may be between 0.2 and 0.4 millimetres.

A depth of the spacer layer may be between 0.1 and 0.5 millimetres, preferably between 0.2 and 0.4 millimetres. As used herein the depth of the spacer layer may be defined as the sum of a maximum distance, along plane perpendicular to the first side, from a central axis to the first side of the spacer layer and a maximum distance, along plane perpendicular to the second side, from a central axis to the second side of the spacer layer.

According to a second aspect of the present disclosure there is provided a cartridge for use in an aerosol-generating system. The cartridge may comprise a consumable assembly according to the first aspect of the present disclosure and a liquid reservoir for holding a liquid aerosol-forming substrate. The wicking material may be in fluid communication with the liquid reservoir and configured to transport the liquid aerosol-forming substrate between the liquid reservoir and the susceptor.

The cartridge may comprise an air inlet and an air outlet. The cartridge may comprise an airflow passage extending between the air inlet and the air outlet.

At least a portion of the susceptor assembly may be positioned in the airflow passage. A portion of the susceptor may be positioned in the airflow passage.

The susceptor may be in fluid communication with the airflow passage. Aerosol-forming substrate vaporised by the susceptor assembly may escape into the airflow passage. The vapour may condense to form an aerosol within the airflow passage. The aerosol may be drawn out of the aerosol-generating system through the air outlet.

The cartridge may comprise a mouth end and a connection end, wherein the connection end is configured to connect the cartridge to an aerosol-generating device. The air outlet may be provided in the mouth end.

The cartridge may comprise a mouthpiece. The air outlet may be defined in the mouthpiece.

The airflow passage may pass through the liquid reservoir. For example, the liquid reservoir may have an annular cross-section defining an internal passage, and the airflow passage may extend through the internal passage of the liquid reservoir.

The cartridge may comprise a susceptor holder. The susceptor holder may be a tubular susceptor holder. The internal passage of the tubular susceptor holder may form a portion of the enclosed airflow passage. The enclosed airflow passage may extend from the air inlet, through the internal passage of the tubular susceptor holder, through the internal passage of the liquid reservoir to the air outlet.

The susceptor holder may support the susceptor assembly. The susceptor holder may contact at least one of the first wicking layer and the second wicking layer. The susceptor holder may secure the susceptor assembly in position in the cartridge.

According to the third aspect of the present disclosure there is provided an aerosol-generating system. The aerosol generating system may comprise a consumable assembly according to the first aspect of the present disclosure. The aerosol generating system may further comprise a liquid reservoir for holding a liquid aerosol-forming substrate, wherein the wicking material is in fluid communication with the liquid reservoir and configured to transport the liquid aerosol-forming substrate. The aerosol generating system may further comprise an inductor coil, and a power supply connected to the inductor coil, the power supply configured to provide alternating current to the inductor coil to generate an alternating magnetic field. The susceptor may be configured to be heated by the alternating magnetic field.

The aerosol-generating system may comprise a system air inlet, a system air outlet and a system airflow passage extending between the system air inlet and the system air outlet.

At least a portion of the susceptor assembly may be positioned in the system airflow passage. At least a portion of the susceptor may be positioned in the system airflow passage.

The susceptor may be in fluid communication with the system airflow passage. Aerosol-forming substrate vaporised by the susceptor assembly may escape into the airflow passage. The vapour may condense to form an aerosol within the system airflow passage. The aerosol may be drawn out of the aerosol-generating system through the system air outlet.

The aerosol-generating system may comprise a mouthpiece wherein the system air outlet is defined in the mouthpiece.

The aerosol-generating system may be a handheld aerosol-generating system configured to allow a user to puff on the mouthpiece to draw an aerosol through the system air outlet. The aerosol-generating system may have a size comparable to a conventional cigar or cigarette. The aerosol-generating system may have a total length between about 30 millimetres and about 150 millimetres. The aerosol-generating system may have an external diameter between about 5 millimetres and about 30 millimetres. The aerosol-generating system may be an electrically operated smoking device.

The aerosol-generating system may comprise control circuitry. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the inductor coil continuously following activation of the system or may be configured to supply power intermittently, such as on a puff-by-puff basis. The power may be supplied to the inductive heating assembly in the form of pulses of electrical current, for example, by means of pulse width modulation (PWM). The control circuitry may comprise DC/AC inverter, which may comprise a Class-D or Class-E power amplifier. The control circuitry may comprise further electronic components. For example, in some embodiments, the control circuitry may comprise any of: sensors, switches, display elements.

The control circuitry may comprise a sensor for detecting when a user puffs on the aerosol-generating system. The sensor may be configured to detect when air is drawn through the system air flow passage. The sensor may allow the aerosol-generating system to supply power on a puff-by-puff basis.

The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the susceptor assembly.

The aerosol-generating system may comprise a cartridge according to the second aspect of the present disclosure and an aerosol-generating device. The system air outlet may comprise the cartridge air outlet.

The aerosol-generating device may comprise the inductor coil, and the power supply connected to the inductor coil. The aerosol-generating device may have a connection end configured to connect the aerosol-generating device to the cartridge. The connection end may comprise a cavity for receiving the cartridge.

The aerosol-generating device may have a distal end, opposite the connection end. The distal end may comprise an electrical connector configured to connect the aerosol-generating device to an electrical connector of an external power source, for charging the power supply of the aerosol-generating device.

It will be appreciated that any features described herein in relation to one aspect the consumable assembly may also be applicable to other aspects of cartridges and aerosol-generating systems according to this disclosure. A feature described in relation to one aspect of the disclosure may be equally applicable to another aspect in accordance with this disclosure.

As used herein, the term “aerosol-forming substrate” refers to a substrate capable of releasing volatile compounds that can form an aerosol. The volatile compounds may be released by heating or combusting the aerosol-forming substrate.

The aerosol-forming substrate may comprise an aerosol former. As used herein, the term “aerosol-former” refers to any suitable compound or mixture of compounds that, in use, facilitates formation of an aerosol, for example a stable aerosol that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

The aerosol-forming substrate may comprise nicotine. The aerosol-forming substrate may comprise water. The aerosol-forming substrate may comprise glycerol, also referred to as glycerine, which has a higher boiling point than nicotine. The aerosol-forming substrate may comprise propylene glycol. The aerosol-forming substrate may comprise plant-based material. The aerosol-forming substrate may comprise homogenised plant-based material. The aerosol-forming substrate may comprise tobacco. The aerosol-forming substrate may comprise a tobacco-containing material. The tobacco-containing material may contain volatile tobacco flavour compounds. These compounds may be released from the aerosol-forming substrate upon heating. The aerosol-forming substrate may comprise homogenised tobacco material. The aerosol-forming substrate may comprise other additives and ingredients, such as flavourants.

As used herein, the term “liquid aerosol-forming substrate” is used to refer to an aerosol-forming substrate in condensed form. Thus, the “liquid aerosol-forming substrate” may be, or may comprise, one or more of a liquid, gel, or paste. If the liquid aerosol-forming substrate is, or comprises, a gel or paste, the gel or paste may liquidise upon heating. For example, the gel or paste may liquidise upon heating to a temperature of less than 50, 75, 100, 150, or 200 degrees Celsius.

According to a fourth aspect of the present disclosure, there is provided a method for manufacturing a consumable assembly. The method may comprise providing one or more susceptors across a strip of wicking material to form a respective one or more susceptor assemblies. The method may further comprise sliding one or more first susceptor holder portions onto the strip of wicking material to engage the respective one or more susceptor assemblies. The one or more first susceptor holder portions may each comprise a hollow elongate portion having an opening at a connection end. The hollow elongate portion may comprise two opposing slots extending from the opening at the connection end along the elongate portion. The slots may be configured to receive and engage the strip of wicking material either side of the susceptor assembly as the susceptor assembly is received within the hollow elongate portion of the first susceptor holder portion. The method may then comprise attaching a second susceptor holder portion to the connection end of each of the one or more first susceptor holder portions to retain the strip of wicking material comprising the one or more susceptor assemblies within the respective one or more first susceptor holder portions.

As mentioned above, forming two portions of a susceptor holder around a strip of wicking material comprising a susceptor assembly facilitates the rapid construction of a consumable assembly. Rather than awkwardly feeding a susceptor assembly through a slot in a wall of a susceptor holder and securing the susceptor assembly in place within the susceptor holder while maintaining a portion of wicking material outside the susceptor holder, a susceptor assembly formed on a strip of wicking material is fed into the hollow elongate portion of the first susceptor holder portion via the opening in the connection end while portions of the strip of wicking material are received within the slots in the first susceptor holder portion. The susceptor assembly is then retained within the first susceptor holder portion by attaching a second susceptor holder portion to the connection end of the first susceptor holder portion. The propose manufacturing method therefore removes the need for precise positioning of a susceptor assembly through a slot in a susceptor holder, and instead presents techniques for reliable assembling a susceptor holder around a susceptor assembly in order to improve the manufacturing efficiency of consumable assemblies.

The second susceptor holder portion may retain the susceptor assembly within the first susceptor portion via any of the mechanisms mentioned in relation to the first aspect.

The method may comprise securing the one or more susceptors to the wicking material by folding free edges of the one or more susceptors around the strip of wicking material.

The method may comprise providing the one or more susceptors across the width of the strip of wicking material.

The method may comprise providing a plurality of susceptors on the strip of wicking material to form a respective plurality of susceptor assemblies. Where a plurality of susceptors are provided on the wicking material, each of the plurality of susceptors may be spaced apart along the length of the strip of wicking material.

The method may comprise folding the strip of wicking material comprising the one or more susceptors widthways such that the one or more susceptors are provided on an outer surface of each side of the folded strip of wicking material. Advantageously, by folding a strip of wicking material comprising one or more susceptors in this manner efficiently forms one or more susceptor assemblies comprising two susceptor layers outside two inner wicking layers. Free edges of the one or more folded susceptor may be welded together to prevent the strip of wicking material form unfolding itself. Prior to folding the strip of wicking material, a spacer layer may be provided underneath the wicking material. This ensures that once the strip of wicking material is folded, the spacer layer separates the two inner wicking layers, thereby creating a susceptor assembly comprising a spacer layer, as described in relation to the earlier aspects.

The method may comprise cutting the strip of wicking material outside of the first susceptor holder portions to separate each of the first susceptor holder portions from the remainder of the strip of wicking material to form a plurality of consumable assemblies, while maintaining exposed portions of the wicking material outside of the plurality of first susceptor holder portions. This advantageously facilitates the efficient manufacturing of multiple consumable assemblies from a single strip of wicking material.

The method may comprise inserting the consumable assembly into a cartridge housing, the cartridge housing and the consumable assembly forming a cartridge comprising a reservoir. When inserted into the cartridge housing, exposed portions of wicking material protruding from the slots in the first susceptor assembly portion may be in fluid communication with the reservoir.

The method may comprise inserting the cartridge into an aerosol-generating device.

According to a fifth aspect of the present disclosure, there is provided a method for manufacturing a consumable assembly. The method may comprise providing a plurality of susceptors spaced apart across a strip of wicking material to form a respective plurality of susceptor assemblies. A plurality of first susceptor holder portions may be provided. The plurality of first susceptor holder portions may each comprising a hollow elongate portion. The hollow elongate portion may comprise two opposing slots extending longitudinally along the elongate portion. The slots may be configured to receive the strip of wicking material comprising the plurality of susceptor assemblies. The method may further comprise feeding the strip of wicking material comprising the plurality of susceptor assemblies through the slots of the plurality of first susceptor holder portions such that the plurality of susceptor holder portions are each aligned over a respective susceptor assembly. The method may comprise cutting the strip of wicking material outside of the plurality of first susceptor holder portions to separate each of the plurality of first susceptor holder portions from the remainder of the strip of wicking material to form a plurality of consumable assemblies, while maintaining exposed portions of the wicking material outside of the plurality of first susceptor holder portions.

Advantageously, the proposed method may improve the manufacturing efficiency of consumable assemblies. Rather than feeding individual susceptor assemblies into a slot in a susceptor holder, the proposed method provides a plurality of susceptor assemblies on a strip of wicking material which is sequentially fed through slots in a plurality of susceptor holders such that each of the susceptor assemblies are aligned within a respective susceptor holder. The wicking material outside each of the susceptor holders are then cut to produce a plurality of susceptor assemblies.

The method may comprise attaching a second susceptor holder portion to each of the plurality of first susceptor holder portions to retain each of the plurality of susceptor assemblies within the respective first susceptor holder portion. The second susceptor holder portion may retain the susceptor assembly within the first susceptor portion via any of the mechanisms mentioned in relation to the first aspect.

The method may comprise securing the one or more susceptors to the wicking material by folding free edges of the one or more susceptors around the strip of wicking material.

The method may comprise providing the one or more susceptors across the width of the strip of wicking material.

As described in relation to the fourth aspect, the method may comprise folding the strip of wicking material widthways such that the one or more susceptors are provided on an outer surface of each side of the folded strip of wicking material. Advantageously, by folding a strip of wicking material comprising one or more susceptors in this manner efficiently forms one or more susceptor assemblies comprising two susceptor layers outside two inner wicking layers. Prior to folding the strip of wicking material, a spacer layer may be provided underneath the wicking material. This ensures that once the strip of wicking material is folded, the spacer layer separates the two inner wicking layers, thereby creating a susceptor assembly comprising a spacer layer, as described in relation to the earlier aspects.

The method may comprise inserting the consumable assembly into a cartridge housing, the cartridge housing and the consumable assembly forming a cartridge comprising a reservoir. When inserted into the cartridge housing, exposed portions of wicking material protruding may be in fluid communication with the reservoir.

The method may comprise inserting the cartridge into an aerosol-generating device.

The invention is defined in the claims. However, below there is provided a non-exhaustive list of non-limiting examples. Any one or more of the features of these examples may be combined with any one or more features of another example, embodiment, or aspect described herein.
Ex1. A method for manufacturing one or more consumable assemblies for an aerosol-generating device, the method comprising:
providing one or more susceptors across a strip of wicking material to form a respective one or more susceptor assemblies;
sliding one or more first susceptor holder portions onto the strip of wicking material to engage the respective one or more susceptor assemblies, the one or more first susceptor holder portions each comprising a hollow elongate portion having an opening at a connection end, the hollow elongate portion comprising two opposing slots extending from the opening at the connection end along the elongate portion, wherein the slots are configured to receive and engage the strip of wicking material either side of the susceptor assembly as the susceptor assembly is received within the hollow elongate portion of the first susceptor holder portion; and
attaching a second susceptor holder portion to the connection end of each of the one or more first susceptor holder portions to retain the strip of wicking material comprising the one or more susceptor assemblies within the respective one or more first susceptor holder portions.
Ex2. The method according to Ex1, the method further comprising providing one or more spacer elements on the opposite side of the strip of wicking material to the respective one or more susceptors, wherein the one or more spacer elements at least partially align with the respective one or more susceptors.
Ex3. The method according to Ex2, wherein the one or more spacer elements comprise a porous material.
Ex4. The method according to any one of Ex2-Ex3, wherein the one or more spacer elements comprise a mesh.
Ex5. The method according to any one of Ex2-Ex4, wherein the one or more spacer elements comprise an aperture for allowing transport of liquid aerosol-forming substrate through the one or more spacer elements.
Ex6. The method according to Ex5, wherein the one or more spacer elements comprise a plurality of apertures for allowing transport of liquid aerosol-forming substrate through the one or more spacer elements.
Ex.7 The method according to any one of Ex5-Ex6, wherein the aperture or apertures have a circular cross-section.
Ex8. The method according to any one of Ex5-Ex7, wherein the aperture or apertures comprise a partial perforation in the one or more spacer elements.
Ex9. The method according to any one of Ex2-Ex8, the method further comprising corrugating the one or more spacer elements to form wave corrugations or triangular corrugations.
Ex10. The method according to any one of Ex2-Ex9, wherein the one or more spacer elements comprises cotton.
Ex11. The method according to any one of Ex2-Ex10, wherein the one or more spacer elements comprises a plastics material.
Ex12. The method according to any one of Ex2-Ex11, wherein the one or more spacer elements comprises a PEEK film.
Ex13. The method according to any one of Ex2-Ex12, wherein the one or more spacer elements comprises a fibre sheet.
Ex14. The method according to any one of Ex2-Ex13, wherein the one or more spacer elements have a higher permeability than the permeability of the strip of wicking material.
Ex15. The method according to any one of Ex1-Ex14, wherein the one or more susceptors are fluid permeable.
Ex16. The method according to any one of Ex1-Ex15, wherein the one or more susceptors comprises electrically conductive filaments.
Ex17. The method according to any one of Ex1-Ex16, wherein the one or more susceptors comprises a mesh.
Ex18. The method according to any one of Ex1-Ex17, wherein the strip of wicking material comprises cotton.
Ex19. The method according to any of Ex1-Ex18, wherein the one or more susceptor assemblies have a thickness which is larger than the width of the slots in the one or more first susceptor holder portions.
Ex20. The method according to any of Ex1-Ex19, wherein the width of the slots increases at the connection end.
Ex21. The method according to any of Ex1-Ex20, wherein the second susceptor holder portion forms a snap-fit connection with the connection end when attached to the first susceptor holder portion.
Ex22. The method according to any of Ex1-Ex21, wherein the second susceptor holder portion exerts a biasing force on the susceptor assembly when attached to the first susceptor holder portion.
Ex23. The method according to any of Ex1-Ex22, wherein the second susceptor holder portion comprises a hollow portion and an opening at a connection end for connection with the connection end of first susceptor holder portion, wherein the connection end of the second susceptor holder portion comprises two opposing slots extending from the opening, wherein the slots in the second susceptor holder portion are configured to receive at least a portion of the strip of wicking material when the second susceptor holder portion is attached to the first susceptor holder portion.
Ex24. A method for manufacturing one or more consumable assemblies for an aerosol-generating device, the method comprising:
   providing a plurality of susceptors spaced apart across a strip of wicking material to form a respective plurality of susceptor assemblies;
   providing a plurality of first susceptor holder portions, the plurality of first susceptor holder portions each comprising a hollow elongate portion, the hollow elongate portion comprising two opposing slots extending longitudinally along the elongate portion, wherein the slots are configured to receive the strip of wicking material comprising the plurality susceptor assemblies;
   feeding the strip of wicking material comprising the plurality of susceptor assemblies through the slots of the plurality of first susceptor holder portions such that the plurality of susceptor holder portions are each aligned over a respective susceptor assembly; and
   cutting the strip of wicking material outside of the plurality of first susceptor holder portions to separate each of the plurality of first susceptor holder portions from the remainder of the strip of wicking material while maintaining exposed portions of the wicking material outside of the plurality of first susceptor holder portions.
Ex25. The method according to Ex24, the method further comprising securing the plurality of susceptors to the wicking material by folding free edges of the plurality of susceptors around the strip of wicking material.
Ex26. The method according to any of Ex24-Ex25, wherein the plurality of susceptors are provided across the width of the strip of wicking material.
Ex27. The method according to Ex26, the method further comprising folding the strip of wicking material widthways such that the plurality of susceptors are provided on an outer surface of each side of the folded strip of wicking material.
Ex28. The method according to any one of Ex24-Ex27, the method further comprising providing a plurality of spacer elements on the opposite side of the strip of wicking material to the respective plurality of susceptors, wherein the plurality of spacer elements each at least partially align with a respective susceptor.
Ex29. The method according to Ex28, wherein the plurality of spacer elements comprise a porous material.
Ex30. The method according to any one of Ex28-Ex29, wherein the plurality of spacer elements comprise a mesh.
Ex31. The method according to any one of Ex28-Ex30, wherein the plurality of spacer elements each comprise an aperture for allowing transport of liquid aerosol-forming substrate through the respective spacer element.
Ex32. The method according to Ex31, wherein the plurality of spacer elements each comprise a plurality of apertures for allowing transport of liquid aerosol-forming substrate through the respective spacer element.
Ex33. The method according to any one of Ex31-Ex32, wherein the aperture or apertures have a circular cross-section.
Ex34. The method according to any one of Ex31-Ex33, wherein the aperture or apertures comprise a partial perforation in the spacer element.
Ex35. The method according to any one of Ex28-Ex34, the method further comprising corrugating the plurality of spacer elements to form wave corrugations or triangular corrugations.
Ex36. The method according to any one of Ex28-Ex35, wherein the plurality of spacer elements comprises cotton.
Ex37. The method according to any one of Ex28-Ex36, wherein the plurality of spacer elements comprises a plastics material.
Ex38. The method according to any one of Ex28-Ex37, wherein the plurality of spacer elements comprises a PEEK film.
Ex39. The method according to any one of Ex28-Ex38, wherein the plurality of spacer elements comprises a fibre sheet.
Ex40. The method according to any one of Ex28-Ex39, wherein the plurality of spacer elements have a higher permeability than the permeability of the strip of wicking material.
Ex41. The method according to any one of Ex24-Ex40, wherein the plurality of susceptors are fluid permeable.
Ex42. The method according to any one of Ex24-Ex41, wherein the plurality of susceptors comprises electrically conductive filaments.
Ex43. The method according to any one of Ex24-Ex42, wherein the plurality of susceptors comprises a mesh.
Ex44. The method according to any one of Ex24-Ex43, wherein the strip of wicking material comprises cotton.
Ex45. The method according to any of Ex25-Ex44, wherein the second susceptor holder portion forms a snap-fit connection with the connection end when attached to the first susceptor holder portion.
Ex46. The method according to any of Ex25-Ex45, wherein the second susceptor holder portion exerts clamping pressure on the wicking material when attached to the first susceptor holder portion.
Ex47. A consumable assembly for use in an aerosol-generating device, the consumable assembly comprising a susceptor holder housing a susceptor assembly comprising a susceptor on a strip of wicking material, the susceptor holder comprising:
   a first portion comprising a hollow elongate portion housing the susceptor assembly, the hollow elongate portion having an opening at a connection end, the hollow elongate portion comprising two opposing slots extending from the opening at the connection end along the elongate portion, wherein wicking material either side of the susceptor of the susceptor assembly protrudes through the slots in the first portion; and
   a second portion attached to the connection end of the first portion to retain the susceptor assembly within the first portion.
Ex48. The consumable assembly according to Ex47, wherein the susceptor is fluid permeable.
Ex49. The consumable assembly according to any of Ex47-Ex48, wherein the susceptor comprises electrically conductive filaments.
Ex50. The consumable assembly according to any of Ex47-Ex49, wherein the susceptor comprises a mesh.
Ex51. The consumable assembly according to any of Ex47-Ex50, wherein the wicking material comprises cotton.
Ex52. The consumable assembly according to any of Ex47-Ex51, wherein the width of the slots increases at the connection end.
Ex53. The consumable assembly according to any of Ex47-Ex52, wherein the second portion forms a snap-fit connection with the connection end of the first portion.
Ex54. The consumable assembly according to any of Ex47-Ex53, wherein the second portion attached to the first portion exerts biasing force on the susceptor assembly.
Ex55. A cartridge comprising a reservoir and a consumable assembly according to any of Ex47-Ex 54, wherein exposed portions of wicking material protruding through the slots in the first susceptor holder portion are in fluid communication with the reservoir.
Ex56. An aerosol-generating device comprising the cartridge of Ex55.

Examples will now be further described with reference to the figures in which:

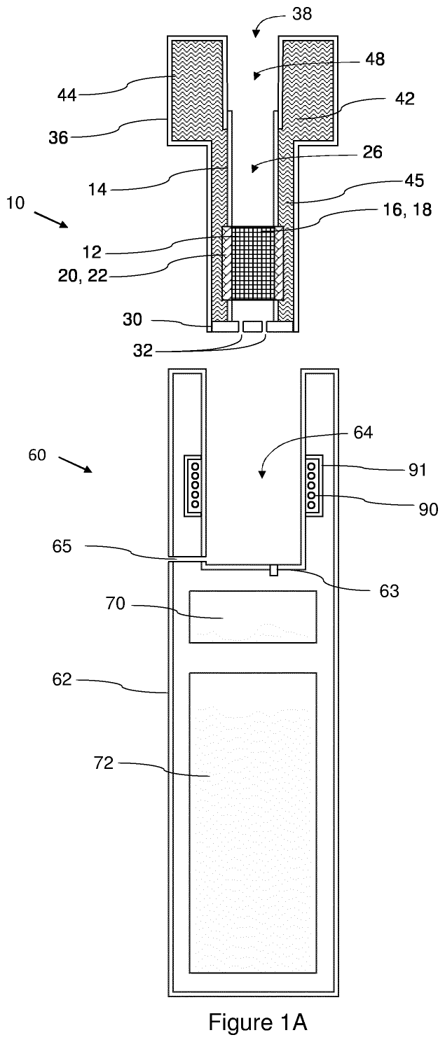

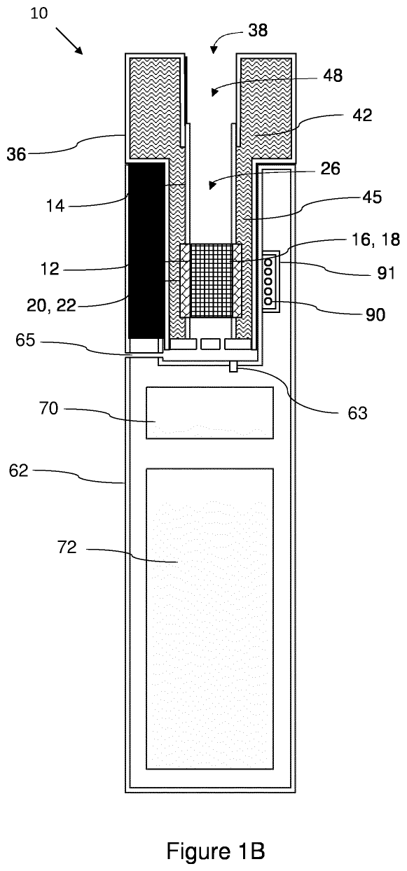

FIG. 1A shows a schematic illustration of a cross section of an aerosol-generating system according to an embodiment of the present disclosure;

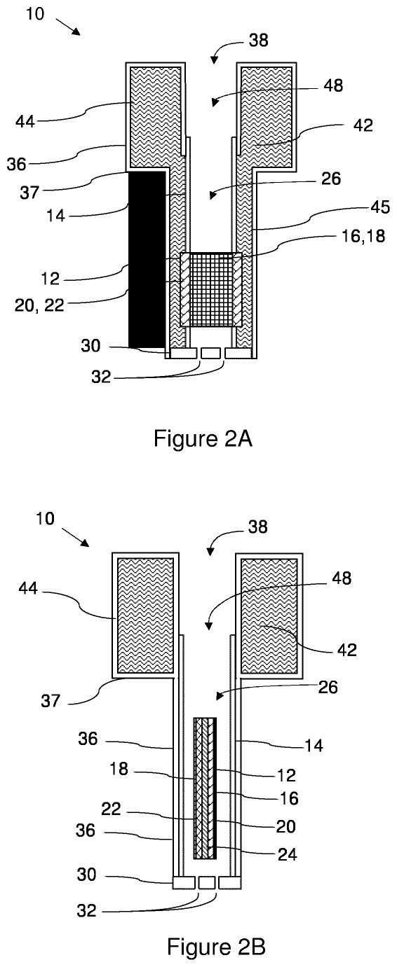

FIG. 1B shows a schematic illustration of a cross section of the aerosol-generating system of FIG. 1A, wherein the system is in use configuration; and FIG. 2A shows a schematic illustration of a cross section of the cartridge of FIG. 1A and 1B;

FIG. 2B shows a schematic illustration of a cross section of the cartridge of FIG. 2A rotated by 90 degrees about a central longitudinal axis of the cartridge;

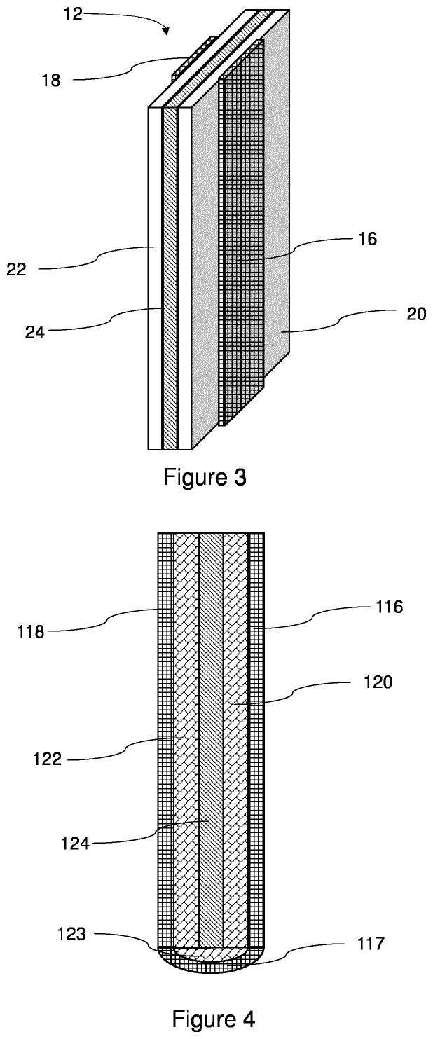

FIG. 3 shows a schematic illustration a perspective view of the susceptor assembly shown in FIGS. 1A-2B;

FIG. 4 shows a schematic side view of a susceptor assembly according to an embodiment of the present disclosure;

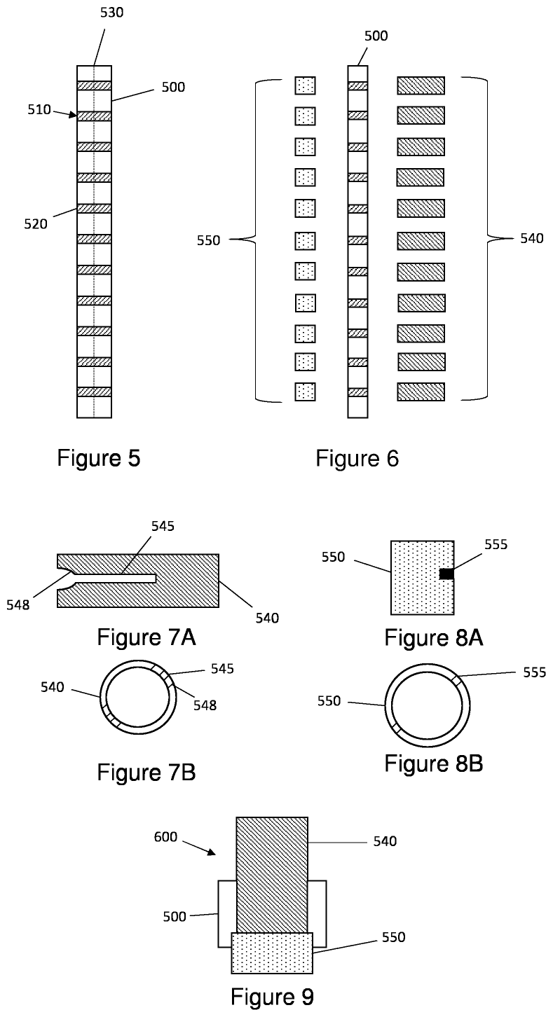

FIG. 5 shows a schematic illustration of strip of wicking material comprising a plurality of susceptor assemblies according to an embodiment of the present disclosure;

FIG. 6 shows a schematic illustration of the strip of wicking material of FIG. 5 folded widthways and an array of first and second susceptor holder portions according to an embodiment of the disclosure.

FIG. 7A shows a schematic side view of a first susceptor holder portion of FIG. 6.

FIG. 7B shows a cross-sectional view of the first susceptor holder portion of FIG. 7A.

FIG. 8A shows a schematic side view of a second susceptor holder portion of FIG. 6.

FIG. 8B shows a cross-sectional view of the second susceptor holder portion of FIG. 8A.

FIG. 9 shows a schematic illustration of a consumable assembly according to an embodiment of the disclosure.

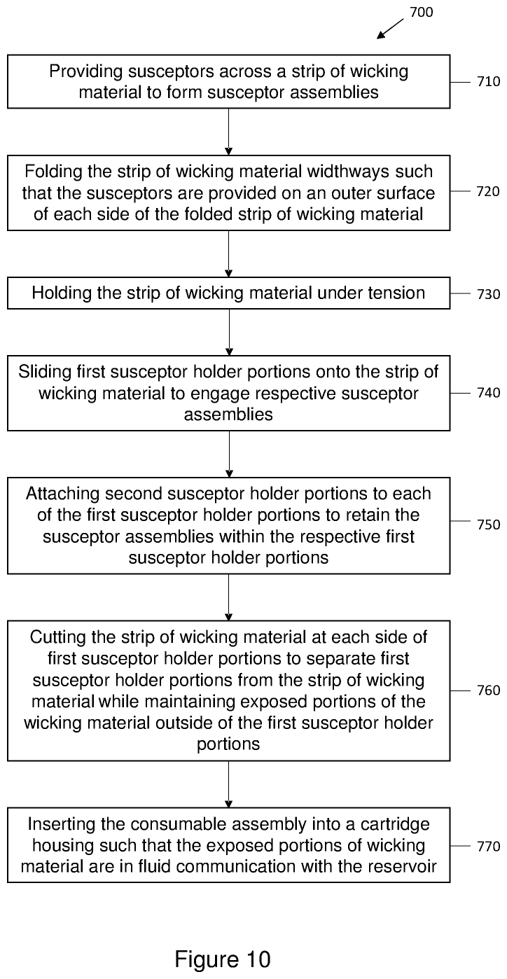

FIG. 10 shows a flow diagram of a method for manufacturing a consumable assembly according to an embodiment of the disclosure.

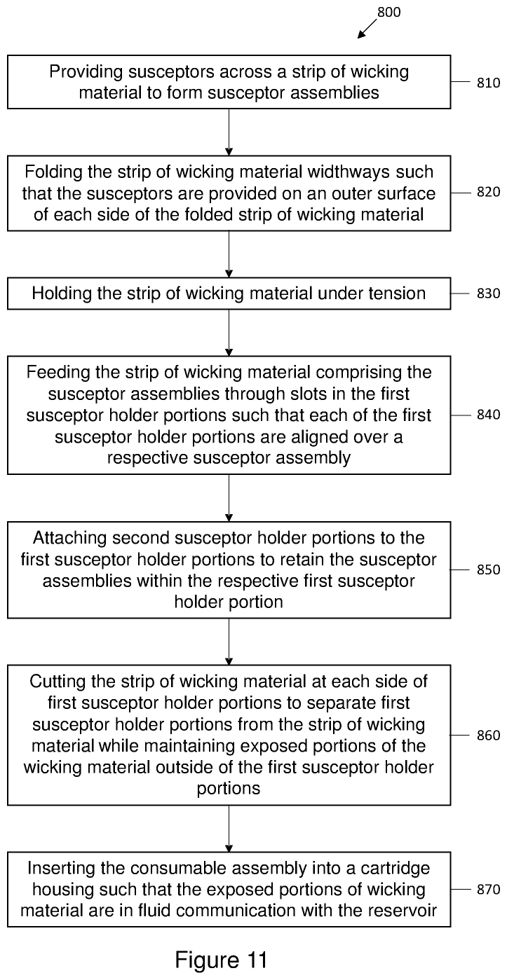

FIG. 11 shows a flow diagram of a method for manufacturing a consumable assembly according to an embodiment of the disclosure.

FIG. 1A shows a schematic illustration of an aerosol-generating system according to an example of the present disclosure. The system comprises a cartridge 10 and a device 60, which can be coupled together to form the aerosol-generating system. The aerosol-generating system is portable and has a size comparable to a conventional cigar or cigarette.

FIG. 1B shows a schematic illustration of an aerosol-generating system of FIG. 1A with the cartridge 10 and device 60 coupled together to form the aerosol-generating system.

The cartridge 10 comprises a susceptor assembly 12 mounted in a susceptor holder 14. The cartridge 10 is shown in FIGS. 2A and 2B separately from the aerosol-generating system. FIGS. 3 shows the susceptor assembly in more detail.

The susceptor assembly 12 is planar, and thin, having a thickness dimension that is substantially smaller than a length dimension and a width dimension. The susceptor assembly 12 is shaped in the form of a rectangle.

The susceptor assembly comprises a susceptor comprising a first susceptor layer 16 and a second susceptor layer 18. The susceptor assembly also comprises a wicking material for transporting a liquid aerosol-forming substrate, the wicking material comprises a first wicking layer 20 and a second wicking layer 22. The susceptor assembly further comprises a spacer layer, not shown in FIG. 1A. Each of the first susceptor layer 16, the second susceptor layer 18, and the first wicking layer 20 and the second wicking layer 22 generally forms the shape of a rectangle, and each susceptor layer has the same length and width dimensions, and the width of the susceptors 16, 18 is smaller than the width of the first wicking layer 20 and the second wicking layer 22. Each of the first wicking layer 20 and the second wicking layer 22 therefore comprise outer, exposed portions of wicking material, each protruding into one of two channels 45. The first and second susceptor layer 16, 18 are substantially identical, and comprise a sintered mesh formed from ferritic stainless steel filaments and austenitic stainless steel filaments. The first wicking layer 20 and the second wicking layer 22 comprise a porous body of cotton filaments. The wicking material 20 is configured to deliver liquid from the outer, exposed surfaces of the first wicking layer 20 and the second wicking layer 22 to the first and second susceptors 16, 18.

The first and second susceptors 16, 18 are configured to be heatable by penetration with an alternating magnetic field, for vaporising an aerosol-forming substrate. The wicking material 20 contacts the susceptor holder 14, such that the susceptor holder 14 supports the susceptor assembly 12 in position in the cartridge 10.

The susceptor assembly 12 is partially arranged inside the internal passage 26 of the tubular susceptor holder 14, and extends in a plane parallel to a central longitudinal axis of the susceptor holder 14. The first and second susceptors 16, 18 are arranged entirely within the internal passage 26 of the susceptor holder 14. The first wicking layer 20 and the second wicking layer 22 of the wicking material, extend through openings in the side wall of the susceptor holder 14 into one of two channels 45.

The cartridge 10 has a mouth end, and a connection end, opposite the mouth end. An outer housing 36 defines a mouth end opening 38 at the mouth end of the cartridge 10. The cartridge 10 may further comprise a mouthpiece, at the mouth end. The connection end is configured for connection of the cartridge 10 to an aerosol-generating device, as described in detail below. The susceptor assembly 12 and the susceptor holder 14 are located towards the connection end of the cartridge 10.

The outer housing 36 formed from a mouldable plastics material, such as polypropylene. The outer housing 36 defines an internal space in which the susceptor assembly 12 and the susceptor holder 14 are contained.

The external width of the outer housing 36 is greater at the mouth end of the cartridge 10 than at the connection end, which are joined by a shoulder 37. This enables the connection end of the cartridge 10 to be received in a cavity of an aerosol-generating device, with the shoulder 37 locating the cartridge in the correct position in the device. This also enables the mouth end of the cartridge 10 to remain outside of the aerosol-generating device, with the mouth end conforming to the external shape of the aerosol-generating device.

The cartridge 10 further comprises a liquid reservoir 44. The liquid reservoir 44 is defined in the cartridge 10 for holding a liquid aerosol-forming substrate 42.

The liquid reservoir 44 extends from the mouth end of the outer housing 36 to the connection end of the outer housing 36, and comprises an annular space defined by the outer housing 36.

The annular space has an internal passage 48 that extends between the mouth end opening 38, and the open end of the internal passage 26 of the susceptor holder 14.

The liquid reservoir 44 further comprises two channels 45, the two channels 45 being defined between an inner surface of the outer housing 36 and an outer surface of the susceptor holder 14. The two channels 45 extend from the annular space defined by the outer housing 36 at the mouth end of the cartridge 10, to the connection end of the cartridge 10, such that the wicking material extends through the openings in the side wall of the susceptor holder 14 into the two channels 45. The two channels 45 extend from the annular space defined by the outer housing 36 at the mouth end of the cartridge 10 on opposite sides of the internal passage 26 of the susceptor holder 14.

The susceptor holder 14 comprises a base 30 that partially closes one end of the internal passage 26. The base 30 comprises a plurality of air inlets 32 that enable air to be drawn into the internal passage 26 through the partially closed end.

An air passage is formed through the cartridge 10 by the internal passage 26 of the susceptor holder 14, and the internal passage 48 of the liquid reservoir 44. The air passage extends from the air inlets 32 in the base 30 of the susceptor holder 14, through the internal passage 26 of the susceptor holder 14, and through the internal passage 48 of the liquid reservoir 44 to the mouth end air outlet 38. The air passage enables air to be drawn through the cartridge 10 from the connection end to the mouth end.

The device 60 comprises a generally cylindrical housing 62 having a connection end and a distal end opposite the connection end. A cavity 64 for receiving the connection end of the cartridge is located at the connection end of the device 60. An air inlet 65 is provided through the outer housing 62 at the base of the cavity 64 to enable ambient air to be drawn into the cavity 64 at the base. The air inlet 65 of the device is the system air inlet.

The device 60 further comprises an inductive heating arrangement arranged within the device outer housing 62. The inductive heating arrangement includes an inductor coil 90, control circuitry 70 and a power supply 72. The power supply 72 comprises a rechargeable nickel cadmium battery, that is rechargeable via an electrical connector (not shown) at the distal end of the device. The control circuitry 70 is connected to the power supply 72, and to the inductor coil 90, such that the control circuitry 70 controls the supply of power to the inductor coil 90. The control circuitry 70 is configured to supply an alternating current to the inductor coil 90.

The inductor coil 90 is positioned around the susceptor assembly 12 when the cartridge 10 is received in the cavity 64, as shown in FIG. 1B. The inductor coil 90 has a size and a shape matching the size and shape of heating regions of the susceptor. The inductor coil 90 is made with a copper wire having a round circular section, and is arranged on a coil former element (not shown). The inductor coil 90 is a helical coil, and has a circular cross section when viewed parallel to the longitudinal axis of the aerosol-generating device.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to reduce the stray power losses from the generated magnetic field.

FIG. 1B shows the aerosol-generating system of FIG. 1A, wherein the cartridge 10 is coupled to the device 60, for operation. In operation, when a user puffs on the mouth end opening 38 of the cartridge 10, ambient air is drawn into the base of the cavity 64 through system air inlet 65, and into the cartridge 10 through the air inlets 32 in the base 30 of the cartridge 10. The ambient air flows through the cartridge 10 from the base 30 to the mouth end air outlet 38, through the air passage, and over the susceptor assembly 12 and in particular over and across the first susceptor layer 16 and the second susceptor layer 18.

The control circuitry 70 controls the supply of electrical power from the power supply 72 to the inductor coil 90 when the system is activated.

The control circuitry 72 includes an airflow sensor 63. The airflow sensor 63 is in fluid communication with the passage of ambient air which is drawn through the system by the user. The control circuitry 72 supplies electrical power to the inductor coil 90 when user puffs on the cartridge 10 are detected by the airflow sensor 63.

When the system is activated, an alternating current is established in the inductor coil 90, which generates alternating magnetic fields in the cavity 64 that penetrate the susceptor assembly 12, causing the susceptor, including the first susceptor layer and the second susceptor layer, to heat. Liquid aerosol-forming substrate in the channels 45 is drawn into the susceptor assembly 12 through the wicking material to the susceptor. In particular, liquid is drawn through the first wicking layer 20 and the second wicking layer 22 to the first susceptor layer 16 and the second susceptor layer 18, respectively. Liquid may also be transferred between the first wicking layer 20 and the second wicking layer 22, through the spacer layer. The liquid aerosol-forming substrate 42 at the susceptor is heated, and volatile compounds from the heated aerosol-forming substrate are released into the air passage of the cartridge 10, which cool to form an aerosol. The aerosol is entrained in the air being drawn through the air passage of the cartridge 10, and is drawn out of the cartridge 10 at the mouth end air outlet 38 for inhalation by the user.

FIG. 2A shows a schematic illustration of the cartridge 10 separately from the aerosol-generating device.

FIG. 2B shows a schematic illustration of the cartridge of FIG. 2A rotated by 90 degrees about a central longitudinal axis of the cartridge. FIG. 2B illustrates the layered structure of the susceptor assembly 12. The susceptor assembly 12 is planar, and thin, having a thickness dimension that is substantially smaller than a length dimension and a width dimension. The susceptor assembly comprises the susceptor, comprising the first susceptor layer 16 and the second susceptor layer 18, and the wicking material for transporting a liquid aerosol-forming substrate. The wicking material comprises the first wicking layer 20 and the second wicking layer 22, with the spacer layer 24 positioned between and in contact with the first wicking layer and the second wicking layer.

The spacer layer 24 is fluid permeable and is configured to allow transport of liquid aerosol-forming substrate between the first wicking layer 20 and the second wicking layer 22. The spacer layer 24 generally forms the shape of a rectangle, and has the same length and width dimensions as the first wicking layer and the second wicking layer. The spacer layer 24 comprises a porous body of cotton.

FIG. 3 shows a schematic illustration a perspective view of the susceptor assembly shown in FIGS. 1A-2B. The width of the susceptor layers 16, 18 is smaller than the width of the first wicking layer 20 and the second wicking layer 22. Therefore, when mounted in a cartridge, the first susceptor layer 16 and the second susceptor layer 18 may be suspended so that they are not in contact with the susceptor holder. In this embodiment, the first susceptor layer 16 and the second susceptor layer 18 are separate components, which are substantially identical. The first wicking layer 20 and the second wicking layer 22 are separate components, which are substantially parallel.

FIG. 4 shows a schematic side view of a susceptor assembly according to a second embodiment of the present disclosure. The susceptor assembly of FIG. 4 is configured to operate in a similar manner to the susceptor assembly according to the first embodiment. The structure of the susceptor assembly of the first embodiment and the susceptor of the second embodiment are largely the same, apart from the differences in the wicking material and the susceptor, as described below.

The susceptor of FIG. 4 comprise a first susceptor layer 116 and a second susceptor layer 118, which are substantially parallel. The susceptor further comprises a connection section 117 joining the first susceptor layer 116 to the second susceptor layer 118. The connection section 117 shown in FIG. 4 is a U-shaped curve. The susceptor is formed by bending or folding a single piece of material to form the susceptor comprising the first susceptor layer 116, the second susceptor layer 118, and the connection section 117. The connection section 117 comprises a sintered mesh formed from ferritic stainless steel filaments and austenitic stainless steel filaments.

In this example, the wicking material comprises a first wicking layer 120, a second wicking layer 122 and a wicking connection section 121 joining the first wicking layer 120 to the second wicking layer 122. The wicking connection section 121 shown in FIG. 4 is a U-shaped curve. The wicking material is formed by bending or folding a single piece of material to form the wicking material comprising the first wicking layer 120, the second wicking layer 122, and the wicking connection section 121. The wicking connection section 121 comprises a porous body of cotton filaments. In other examples, not shown in the Figures, alternative arrangements of the wicking material and susceptor may be possible. For example, susceptor assembly may comprise a susceptor comprising a connection section joining a first susceptor layer to a second susceptor layer, wherein the wicking material comprises a first wicking layer and a second wicking layer that are separate components.

FIG. 5 shows a schematic illustration of strip of wicking material 500 comprising a plurality of susceptor assemblies 510 according to an embodiment of the present disclosure. Susceptor assemblies 510 are formed by providing plurality of susceptors 520 at spaced intervals across the strip of wicking material 500. In order to form a series of susceptor assemblies 510 having multiple layers of wicking material 500 and/or susceptors 520, or even spacer layers, additional susceptors, wicking layers and/or spacer layers may be provided on the top and/or bottom of the strip of wicking material 500. Additionally or alternatively, the strip of wicking material 500 comprising the susceptor assemblies 510 may be folded widthways along a central axis 520 to create two inner wicking layers and two outer susceptor layers. Providing a spacer layer underneath the strip of wicking material may result a central spacer layer separating the two wicking layers when the strip of wicking material is folded, as illustrated in FIG. 4.

FIG. 6 shows a schematic illustration of the strip of wicking material 500 of FIG. 5 folded widthways and an array of first susceptor holder portions 540 and second susceptor holder portions 550 according to an embodiment of the disclosure. First susceptor holder portions 540 are configured to engage with the strip of wicking material 500 and each receive a susceptor assembly 510. Second susceptor holder portions 550 are configured for attachment with first susceptor holder portions 540 to retain the susceptor assemblies 510 within first susceptor holder portions 540.

FIG. 7A-B shows a schematic side view and cross-sectional view of first susceptor holder portion 540 of FIG. 6. First susceptor holder portion 540 comprises a hollow elongate portion having an opening at a connection end. Extending from the opening are two opposing slots 545 along the elongate portion. Slots 545 are configured to receive the strip of wicking material 500 as a susceptor assembly 510 is received within the hollow portion of the first susceptor holder portion 540 via the opening in the connection end. Slots 545 comprise a wider or tapered portion 548 at the opening of the connection end. This facilitates easier insertion of the strip of wicking material 500 within the slots 545.

FIG. 8A-B shows a schematic side view and cross-sectional view of a second susceptor holder portion 550 of FIG. 6. Second susceptor holder portion 550 comprises a hollow elongate portion having an opening at a connection end, which is configured for connection with the connection end in the first susceptor holder portion 540. Extending from the opening are two opposing slots 555 along the elongate portion. Slots 555 are configure to engage with and receive a portion of the strip house wicking material 500 retained within slots 545 of the first susceptor holder portion 540 when the second susceptor holder portion 550 is connected to the first susceptor holder portion 540.

In other examples, not shown in the Figures, alternative arrangements of the first and second susceptor holder portions may be possible. For example, in some embodiments, the second susceptor holder portion 550 be received within the first susceptor holder portion 540 and retain the susceptor assembly 510 within the first susceptor holder portion 540 by blocking a portion of the opening at the connection end. In other embodiments, the second susceptor holder portion 550 may retain the susceptor assembly 510 within the first susceptor holder portion 540 by causing deformation of the first susceptor holder portion 540 onto the susceptor assembly 510. In other embodiments, the second susceptor holder portion 550 may retain the susceptor assembly 510 within the first susceptor holder portion 540 by applying a biasing force on the susceptor assembly 510 or a portion of the strip of wicking material 500 against the first susceptor holder portion 540.

FIG. 9 shows a schematic illustration of a consumable assembly 600 according to an embodiment of the disclosure. Consumable assembly 600 comprising a strip of wicking material 500, the strip of wicking material 500 comprising a susceptor assembly 510 housed within the hollow portion of a first susceptor holder portion 540. The susceptor assembly 510 is retained within the first susceptor holder portion 540 by a second susceptor holder portion 550 which receives a connection end of the first susceptor holder portion 540 and a portion of the strip of wicking material 500.

FIG. 10 shows a flow diagram of a method 700 for manufacturing a consumable assembly 600 according to an embodiment of the disclosure. Step 710 comprises providing a plurality of susceptors 520 across a strip of wicking material 500 to form a plurality of susceptor assemblies 510. Susceptors 520 are secured to the strip of wicking material 500 by folding free edges of the susceptors 520 around the wicking material 500. Step 720 comprising folding the strip of wicking material 500 widthways along a central axis 530 such that the susceptors 520 are provided on an outer surface of each side of the folded strip of wicking material 500. At step 730, the folded strip of wicking material 500 is held under tension along it's length. This is to facilitate easier insertion of the strip of wicking material 500 into slots 545 of a first susceptor holder portion 540. At step 740, a plurality of first susceptor holder portions 540 each receive a susceptor assembly 510 on the strip of wicking material 500 while portions of the strip of wicking material 500 either side of the susceptor assembly 510 slide into the slots 545 of the first susceptor holder portion 540. Step 750 comprises attaching second susceptor holder portions 550 to the first susceptor holder portion 540 to retain the susceptor assemblies 510 within the respective first susceptor holder portions 540. Step 760 comprises cutting the strip of wicking material outside the first susceptor holder portions 540 to separate first susceptor holder portions 540 from the strip of wicking material 500 to form a plurality of consumable assemblies 600, while maintaining exposed portions of the wicking material 500 outside of the first susceptor holder portions 540. Step 770 comprises inserting the consumable assembly 600 into a cartridge housing 36 to form a cartridge 10 such that the exposed portions of wicking material 500 are in fluid communication with a reservoir 42 in the cartridge 10. The method 700 may further comprise inserting the cartridge 10 into an aerosol-generating device 60 to form an aerosol-generating system.

FIG. 11 shows a flow diagram of a method 800 for manufacturing a consumable assembly 600 according to an embodiment of the disclosure. Steps 810 to 830 correspond with steps 710 to 730 described in relation to method 700. Step 840 comprises feeding the strip of wicking material 500 comprising the plurality of susceptor assemblies 510 through slots 545 in the first susceptor holder portions 540 such that each of the first susceptor holder portions 540 are aligned over a respective susceptor assembly 510. Step 850 comprises attaching second susceptor holder portions 550 to the first susceptor holder portions 540 in order to retain the susceptor assemblies 510 within the respective first susceptor holder portions 540. Step 860 comprises cutting the strip of wicking material 500 outside side of the first susceptor holder portions 540 to separate first susceptor holder portions 540 from the strip of wicking material 500 to form a plurality of consumable assemblies 600, while maintaining exposed portions of the wicking material 500 outside of the first susceptor holder portions 540. Step 870 comprises inserting the consumable assembly 600 into a cartridge housing 36 to form a cartridge 10 such that the exposed portions of wicking material 500 are in fluid communication with a reservoir 42 in the cartridge 10. The method 800 may further comprise inserting the cartridge 10 into an aerosol-generating device 60 to form an aerosol-generating system.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-13. (canceled)

14. A method for manufacturing one or more consumable assemblies for an aerosol-generating device, the method comprising:
providing one or more susceptors across a width of a strip of wicking material to form a respective one or more susceptor assemblies;
folding the strip of wicking material widthways such that the one or more susceptors are provided on an outer surface of each side of the folded strip of wicking material;
sliding one or more first susceptor holder portions onto the strip of wicking material to engage the respective one or more susceptor assemblies, the one or more first susceptor holder portions each comprising a hollow elongate portion having an opening at a connection end, the hollow elongate portion comprising two opposing slots extending from the opening at the connection end along the hollow elongate portion, wherein the slots are configured to receive and engage the strip of wicking material on either side of the susceptor assembly as the susceptor assembly is received within the hollow elongate portion of the first susceptor holder portion; and
attaching a second susceptor holder portion to the connection end of each of the one or more first susceptor holder portions to retain the strip of wicking material comprising the one or more susceptor assemblies within the respective one or more first susceptor holder portions.

15. The method according to claim 14, further comprising securing the one or more susceptors to the wicking material by folding free edges of the one or more susceptors around the strip of wicking material.

16. The method according to claim 14, further comprising providing one or more spacer elements on the opposite side of the strip of wicking material to the respective one or more susceptors, wherein the one or more spacer elements at least partially align with the respective one or more susceptors.

17. The method according to claim 14, further comprising holding the strip of wicking material under tension while sliding the one or more first susceptor holder portions over the one or more susceptor assemblies.

18. The method according to claim 14, wherein a plurality of susceptors are provided at spaced intervals along a length of the strip of wicking material to form a plurality of susceptor assemblies.

19. The method according to claim 18, further comprising cutting the strip of wicking material at each side of the plurality of first susceptor holder portions to separate each of the plurality of first susceptor holder portions from the remainder of the strip of wicking material to form a respective plurality of consumable assemblies while maintaining exposed portions of the wicking material outside of the plurality of first susceptor holder portions.

20. The method according to claim 19,
further comprising inserting the consumable assembly into a cartridge housing, the cartridge housing and the consumable assembly forming a cartridge comprising a reservoir,
wherein the exposed portions of wicking material are in fluid communication with the reservoir.

21. The method according to claim 20, further comprising inserting the cartridge into the aerosol-generating device.

22. A method for manufacturing one or more consumable assemblies for an aerosol-generating device, the method comprising:
providing a plurality of susceptors spaced apart across a strip of wicking material to form a respective plurality of susceptor assemblies;
providing a plurality of first susceptor holder portions each comprising a hollow elongate portion, the hollow elongate portion comprising two opposing slots extending longitudinally along the elongate portion, wherein the two opposing slots are configured to receive the strip of wicking material comprising the plurality of susceptor assemblies;
feeding the strip of wicking material comprising the plurality of susceptor assemblies through the slots of the plurality of first susceptor holder portions such that the plurality of susceptor holder portions are each aligned over a respective susceptor assembly; and
cutting the strip of wicking material outside of the plurality of first susceptor holder portions to separate each of the plurality of first susceptor holder portions from the remainder of the strip of wicking material to form a respective plurality of consumable assemblies while maintaining exposed portions of the wicking material outside of the plurality of first susceptor holder portions.

23. The method according to claim 22, further comprising attaching a second susceptor holder portion to each of the plurality of first susceptor holder portions to retain the strip of wicking material comprising the each of the plurality of susceptor assemblies within the respective first susceptor holder portion.

24. A consumable assembly for an aerosol-generating device, the consumable assembly comprising:
a susceptor holder housing a susceptor assembly comprising a susceptor folded around an outer surface across a width of a strip of folded wicking material, the susceptor holder comprising:
a first portion comprising a hollow elongate portion housing the susceptor assembly, the hollow elongate portion having an opening at a connection end, the hollow elongate portion comprising two opposing slots extending from the opening at the connection end along the elongate portion, wherein wicking material either side of the susceptor of the susceptor assembly protrudes through the slots in the first portion; and
a second portion attached to the connection end of the first portion to retain the susceptor assembly within the first portion.

25. The consumable assembly according to claim 24, wherein the second portion attached to the first portion exerts biasing force on the susceptor assembly.

26. A cartridge comprising a reservoir and a consumable assembly according to claim 24, wherein exposed portions of wicking material protruding through the two opposing slots in the first portion are in fluid communication with the reservoir.
